(19) United States
(12) Patent Application Publication
(10) Pub. No.: US 2017/0079314 A1
(43) Pub. Date: Mar. 23, 2017

(54) Process for Creating Pasta Chips

(71) Applicants: Steven DiFillippo, Gloucester, MA (US); Leigh Stephanie Hernan, Scituate, MA (US)

(72) Inventors: Steven DiFillippo, Gloucester, MA (US); Leigh Stephanie Hernan, Scituate, MA (US)

(21) Appl. No.: 15/268,685

(22) Filed: Sep. 19, 2016

Related U.S. Application Data
(60) Provisional application No. 62/220,035, filed on Sep. 17, 2015.

(51) Int. Cl. A23L 7/13; A23P 30/20; A23L 5/10; A23L 7/109

(52) U.S. Cl. CPC A23L 7/13; A23L 7/111; A23P 30/20; A23L 5/11; A23V 2002/00

(57) ABSTRACT

A process for making pasta chips wherein the pasta chips are made from a mix with semolina, water, and salt, in which the mixture is then placed in a pasta machine to create pasta. The pasta is then cut into chip-like slices. The slices are then cooked, dried and then dusted with a powder substance and flavored appropriately with a variety of different seasonings. The chips are then weighed, portioned, and packaged, or served immediately.

### CROSS REFERENCE TO RELATED APPLICATION

This application claims priority to and takes the benefit of U.S. Provisional Patent Application Ser. No. 62/220,035 filed on Sep. 17, 2015, the contents of which are herein incorporated by reference.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

Field of the Invention

The instant invention relates generally to snack foods, and more specifically to pasta chips.

Description of Related Art

Currently, snack chips qualify as a major contributor to the food chain in many countries, often served with meals or as a pick me up throughout the day or at night. Many brands and varieties of chips are available, and of course many variations of snack chips exist, including but not limited to, potato chips, corn chips, pretzel chips, pita chips, etc. Also within the chip genre exist different variations such as, including but not limited, crisps and thins.

In typical fashion, concurrent chip producers strive to create healthy chips, which retain the great taste of deep fried chips and many are made from a variety of ingredients instead of conventional potatoes, including vegetables and grains.

Additionally, different methods and processes of manufacture are concurrently being utilized, as snacks are well-known and have become a major contributor to the calories consumed by the consuming public. These snack products are usually produced by processes that involve deep fat frying. Attempts to deep fry pasta products have not been successful and, consequently, pasta chips have been absent from the snacks. Therefore, a process for creating a healthy and tasty pasta chip is illustrated herein.

### SUMMARY OF THE INVENTION

The instant apparatus, as illustrated herein, is not anticipated, rendered obvious, or present in any of the prior art mechanisms, either alone or in any combination thereof. Therefore, it is an object of the instant system to provide a system, method, process and accompanying apparatuses for creating pasta chips.

The method of creating pasta chips comprises mixing percentages of semolina, water and salt to create a novel pasta chip mixture. Next, the process includes turning the eventual pasta chip mixture and processing the pasta chip mixture through a pasta machine. Next, the pasta chip mixture is cut into chips and then fried in a specific process. Finally, the pasta chip mixture is dusted with a powder substance and the chips are prepared for serving.

There has thus been outlined, rather broadly, the more important features of the versatile systems, apparatuses and accompany methods for creating pasta chips in order that the detailed description thereof that follows may be better understood, and in order that the present contribution to the art may be better appreciated. There are additional features of the system that will be described hereinafter and which will form the subject matter of the claims appended hereto.

In this respect, before explaining at least one embodiment of the process in detail, it is to be understood that the process is not limited in its application to the details of construction and to the arrangements of the components set forth in the following description or illustrated in the drawings. The process is capable of being utilized in other embodiments and of being practiced and carries out in various ways. Also, it is to be understood that the phraseology and terminology employed herein are for the purpose of description and should not be regarded as limiting.

These, together with other objects of the process, along with the various features of novelty, which characterize the process, are pointed out with particularity in the claims annexed to and forming a part of this disclosure.

### DETAILED DESCRIPTION OF THE SEVERAL EMBODIMENTS

For the following defined terms, these definitions shall be applied, unless a different definition is given in the claims or elsewhere in this specification. All numeric values are herein assumed to be modified by the term “about”, whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

In several embodiments, an amount of semolina is mixed with a certain amount of water and salt to create a pasta chip mixture. In one embodiment, the pasta chip mixture may comprise 72% semolina and 18% water. The mix is turned for 45-60 seconds until it becomes a pasta chip mixture. The pasta chip mixture may be turned up to two more times to achieve the desired consistency.

The pasta chip mixture is next placed in a hopper of a pasta machine until a pasta is produced. In this embodiment a Le Maforrina pasta machine is used, however other pasta machines may be used. In this embodiment the pasta is seasoned with a seasoning, however in other embodiments it may not be seasoned. The pasta is extruded out of the pasta machine onto a conveyor. The conveyor goes into a cutter and out onto another conveyor.

The conveyor then carries the pasta into a fryer and through the fryer phase for a duration of 15 seconds at 375 degrees to create pasta chips. The pasta chips are then taken out of the fryer and allowed to dry for about 13-18 seconds. The pasta chips are then placed into a duster where they are dusted with a powder. The pasta chips are taken out of the duster. In this embodiment the pasta chips are then served, however in other embodiments the pasta chips are then weighed, portioned, and packaged to be served later.

In another embodiment of the process the seasoning includes sriracha hot chili spice, dehydrated garlic, extractive of paprika, dried tomato yeast, xanthan gum, monglycerides, modified cellulose gum, spice, vinegar, and salt.

In another embodiment of the process, the seasoning may include a form of cheese powder, rosemary, thyme, and salt. In another embodiment of the process, the form of cheese powder may contain cheddar cheese, whey, buttermilk, maltodextrin, salt, disodium phosphate.

In another embodiment of the process the seasoning includes cinnamon, sugar, and salt.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub combination.

Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system variants and components in the embodiments described above should not be understood as requiring such separation in all embodiments, and it should be understood that the described components and systems can generally be integrated together in a single software product or packaged into multiple software products.

Particular embodiments of the subject matter have been described. Other embodiments are within the scope of the invention. For example, the actions recited in the description can be performed in a different order and still achieve desirable results.

What is claimed is:

1. A process for making pasta chips comprising:
mixing semolina, water, and salt in a bag to create a mix;
turning the mix until it crumbles;
placing the mix in a hopper of a pasta machine to create a pasta;
extruding the pasta out of the machine;
cutting the pasta;
creating slices comprising a thickness of up to about 0.1 inch;
cooking the pasta chips for 15 seconds at 375 degrees;
drying the pasta chips for about 13-18 seconds;
dusting the pasta chips with a powder substance.

2. The method for making pasta chips of claim 1, wherein the cooking is defined by a deep frying step.

3. The method for making pasta chips of claim 1, wherein the mix is made with 72% semolina and 18% water.

4. The method for making pasta chips of claim 2 wherein the deep frying step is at a temperature between 275 Fahrenheit and 300 Fahrenheit.

5. The method for making pasta chips of claim 1, wherein the pasta is shaped into a form having a thickness between 0.025 and 0.100 inch.

6. The method for making pasta chips of claim 1, wherein the pasta contains up to 15% of a shortening.

7. The method for making pasta chips of claim 1, wherein the mix is turned for 45-60 seconds.

8. The method for making pasta chips of claim 1, wherein the mix is turned up to three times.

9. The method for making pasta chips of claim 1, wherein a quantity of seasoning is added to the pasta after the pasta is placed in the pasta machine.

10. The method for making pasta chips of claim 9, wherein the quantity of seasoning contains sriracha hot chili spice, dehydrated garlic, extractive of paprika, dried tomato yeast, xanthan gum, monglycerides, modified cellulose gum, spice, vinegar, and salt.

11. The method for making pasta chips of claim 9, wherein the quantity of seasoning contains cinnamon, sugar, and salt.

12. The method for making pasta chips of claim 9, wherein the quantity of seasoning contains a cheese powder, a quantity of rosemary, a quantity of thyme, and a quantity of salt.

13. The method for making pasta chips of claim 12, wherein the cheese powder contains cheddar cheese, whey, buttermilk, maltodextrin, salt, disodium phosphate.

14. The method for making pasta chips of claim 1, wherein the chips are further weighed, portioned, and packaged.
